(19) United States
(12) Patent Application Publication
(10) Pub. No.: US 2015/0286671 A1
(43) Pub. Date: Oct. 8, 2015

(54) TRANSACTION SYSTEM

(71) Applicant: NEC CORPORATION, Tokyo (JP)

(72) Inventor: Tomoo Ebiyama, Tokyo (JP)

(73) Assignee: NEC Corporation, Tokyo, (JP)

(21) Appl. No.: 14/438,454

(22) PCT Filed: Aug. 14, 2013
(86) PCT No.: PCT/JP2013/004860

§ 371 Date: Apr. 24, 2015

(30) Foreign Application Priority Data
Oct. 29, 2012 (JP) 2012-237597

(51) Int. Cl. G06F 17/30

(52) U.S. Cl. CPC G06F 17/30348; G06F 17/30371

(57) ABSTRACT

A record data storage unit stores records that are expressed by a set of key and value. A WAL (Write Ahead Logging) storage unit stores an update history in units of data groups, each of which aggregates a plurality of records. A transaction processing unit, upon commitment of a transaction that references and updates the data group, determines the presence or absence of an exclusivity violation in units of the records based on the update history stored in the WAL storage unit, whereupon, if there is no exclusivity violation, the transaction is succeeded and an update history by the transaction is stored in the WAL storage unit. A WAL reflection unit reflects the updated content of the record that is in the update log, which is stored in the WAL storage unit, in a record data storage unit.

This application is a National Stage Entry of PCT/JP2013/004860 filed on Aug. 14, 2013, which claims priority from Japanese Patent Application 2012-237597 filed on Oct. 29, 2012, the contents of all of which are incorporated herein by reference, in their entirety.

### TECHNICAL FIELD

The present invention relates to a transaction system that executes transactions of referencing and updating a plurality of key-value store records, a control method of the transaction system, and a program thereof.

### BACKGROUND ART

In recent years, what is called the Cloud that uses a large number of computers has been attracting much attention as an execution base of scalable applications. In the cloud infrastructure, what is called the Key-Value Store (KVS) has been widely known as scalable data-perpetuation means. However, general KVS allows transactions only for one record.

In view of this problem, the first related technique relating to the present invention proposes a system that supports transactions for a plurality of records, each of which is KVS (for example, refer to NPL 1). In the first related technique, in order to realize a transaction for a plurality of records using KVS, a plurality of records to be processed in a transaction are grouped and written in KVS as a piece of Key Value (KV) data so as to realize a transaction for a plurality of records. In the present application, the data that aggregates a plurality of records into a piece of KV data is referred to as a data group.

Further, the first related technique described above uses optimistic exclusion as an exclusive control mechanism in KVS. In particular, a timestamp is assigned to each record (KV data). The timestamp is acquired when a certain transaction is started, then, at the commitment of a record after updating the record, if the timestamp has not changed since the start time of the transaction, the timestamp is incremented by one and written in the KVS. If the timestamp has changed upon commit time, this means the record has been updated by other transactions between the start of the transaction to the commitment thereof, and therefore, the transaction is failed. In the optimistic exclusion, scale-out becomes easier, as it does not use shared resources such as exclusive control information.

On the other hand, the second related technique relating to the present invention proposes a transaction system that employs what is called the pessimistic exclusion as the exclusive control mechanism (for example, refer to PTL 1). In the second related technique, upon update processing of a data file in accordance with a record update request from a transaction, the exclusive control mechanism controls exclusivity of concurrent accesses to the record to be updated. Further, together with the update of the record in a buffer, the update history of the record in the buffer is generated. Upon commitment of the transaction, the update history that has been generated in units of records for the transaction is stored in a journal file. Then, based on the update history recorded in the journal file, the data file is updated in units of blocks through a write buffer.

Further, the third related technique relating to the present invention proposes, in a shared data management system that manages synchronization of master data at a master site and duplicate data at a local site, determining timing of reflecting update data of master data to duplicate data at a local site based on the urgency of update and the like (for example, refer to PLT 2).

### CITATION LIST

### Patent Literature

PTL 1: Japanese Unexamined Patent Application Publication No. Hei 9-62550
PTL 2: Japanese Unexamined Patent Application Publication No. 2001-350661

### Non Patent Literature

NPL1: “InfoFrame Relational Store,” a New Scale-Out Database for Big Data, SUKENARI Teruki, TAMURA Minoru, NEC TECHNICAL JOURNAL, Vol. 65 No. 2/2012.

### SUMMARY OF INVENTION

### Technical Problem

As described above, KVS is attracting attention as scalable data-perpetuating means, and systems that support transactions of a plurality of records using KVS are proposed. However, the above-described optimistic exclusion mechanism for KVS can implement exclusion only in a unit of records (KV data). In the system that executes transactions by grouping a plurality of records into a piece of KV data, as grouped large KV data is the unit for exclusion, transactions that are not supposed to be determined as violating exclusivity may possibly be determined as violating exclusivity, which causes a problem of lowering simultaneity in executing transactions as well as lowering throughput. While it is conceivable to apply the pessimistic exclusion described in the second related technique relating to the present invention so as to implement exclusion in units of records before grouping into a large piece of KV data, in the pessimistic exclusion, scale-out becomes difficult. Therefore, the effect of using KV data is diminished.

The object of the present invention is to provide a transaction system that solves the above-described problem, that is, a problem of lowering simultaneity in execution of transactions in a system that executes transactions by grouping a plurality of records into a piece of KV data.

### Solution to Problem

A transaction system of a first exemplary aspect of the present invention includes: a record data storage unit that stores records that are each expressed by a set of key and value; a WAL storage unit that stores an update history in units of data groups, each of which aggregates a plurality of the records into a piece of key-value data, a transaction processing unit that, upon commitment of a transaction that references and updates the data group, determines the presence or absence of an exclusivity violation in units of the records based on the update history stored in the WAL storage unit, whereupon, if there is no exclusivity violation, the transaction is succeeded and an update history by the transaction is stored in the WAL storage unit; and a WAL reflection unit that reflects an update content of the records that is in the update history, which is stored in the WAL storage unit, in the record data storage unit.

A transaction system control method of a second exemplary aspect of the present invention is a control method of a transaction system that includes: a record data storage unit that stores records that are each expressed by a set of key and value; a WAL storage unit that stores an update history in units of data groups, each of which aggregates a plurality of the records into a piece of key-value data; a transaction processing unit; and a WAL reflection unit, wherein the transaction system control method includes: upon commitment of a transaction that references and updates the data group, the transaction processing unit determines the presence or absence of an exclusivity violation in units of the records based on the update history stored in the WAL storage unit, whereupon, if there is no exclusivity violation, the transaction is succeeded and an update history by the transaction is stored in the WAL storage unit; and the WAL reflection unit reflects an update content of the records that is in the update history, which is stored in the WAL storage unit, in the record data storage unit.

A computer-readable storage medium of a third exemplary aspect of the present invention stores a program which causes a computer that includes: a record data storage unit that stores records each of which is expressed by a set of key and value; and a WAL storage unit that stores an update history in units of data groups, each of which aggregates a plurality of the records into a piece of key-value data, to function as: a transaction processing unit that, upon commitment of a transaction that references and updates the data group, determines whether there is an exclusivity violation in units of the records based on the update history stored in the WAL storage unit, whereupon, if there is no exclusivity violation, the transaction is succeeded and an update history by the transaction is stored in the WAL storage unit; and a WAL reflection unit that reflects an update content of the records that is in the update history, which is stored in the WAL storage unit, in the record data storage unit.

### Advantageous Effects of Invention

According to the present invention, since the above-described configuration is provided, it is possible to enhance simultaneity in execution of transactions in a system that executes transactions by grouping a plurality of records into a piece of KV data.

### BRIEF DESCRIPTION OF DRAWINGS

FIG. 1 is a block diagram of a first exemplary embodiment of the present invention;

FIG. 2 is a flowchart illustrating an example of operation of a transaction processing unit in the first exemplary embodiment of the present invention;

FIG. 3 is a diagram illustrating an example of data used for describing record data and a data group in the first exemplary embodiment of the present invention;

FIG. 4 is a diagram illustrating an example of data groups in the first exemplary embodiment of the present invention;

FIG. 5 is an explanatory diagram of a WAL stored in a WAL storage unit in the first exemplary embodiment of the present invention;

FIG. 6 is a diagram illustrating an example where an exclusive check processing unit determines the absence of an exclusivity violation in the first exemplary embodiment of the present invention;

FIG. 7 is a diagram illustrating an example where the exclusive check processing unit determines the presence of an exclusivity violation in the first exemplary embodiment of the present invention;

FIG. 8 is a diagram illustrating another example where the exclusive check processing unit determines the absence of an exclusivity violation in the first exemplary embodiment of the present invention;

FIG. 9 is a flowchart illustrating an example of operation of a WAL reflection unit in the first exemplary embodiment of the present invention;

FIG. 10 is a diagram illustrating an example of record data to be reflected by the WAL reflection unit in the first exemplary embodiment of the present invention;

FIG. 11 is a block diagram of a second exemplary embodiment of the present invention;

FIG. 12 is an explanatory diagram where a predetermined number of WALs having newer time stamps are kept undeleted in the second exemplary embodiment of the present invention;

FIG. 13 is a block diagram of a third exemplary embodiment of the present invention;

FIG. 14 is a flowchart illustrating an example of operation of a WAL reflection unit in the third exemplary embodiment of the present invention; and

FIG. 15 is a block diagram of a fourth exemplary embodiment of the present invention.

### DESCRIPTION OF EMBODIMENTS

In the following, the details of the exemplary embodiments of the present invention will be described with reference to the drawings.

### First Exemplary Embodiment

### Configuration

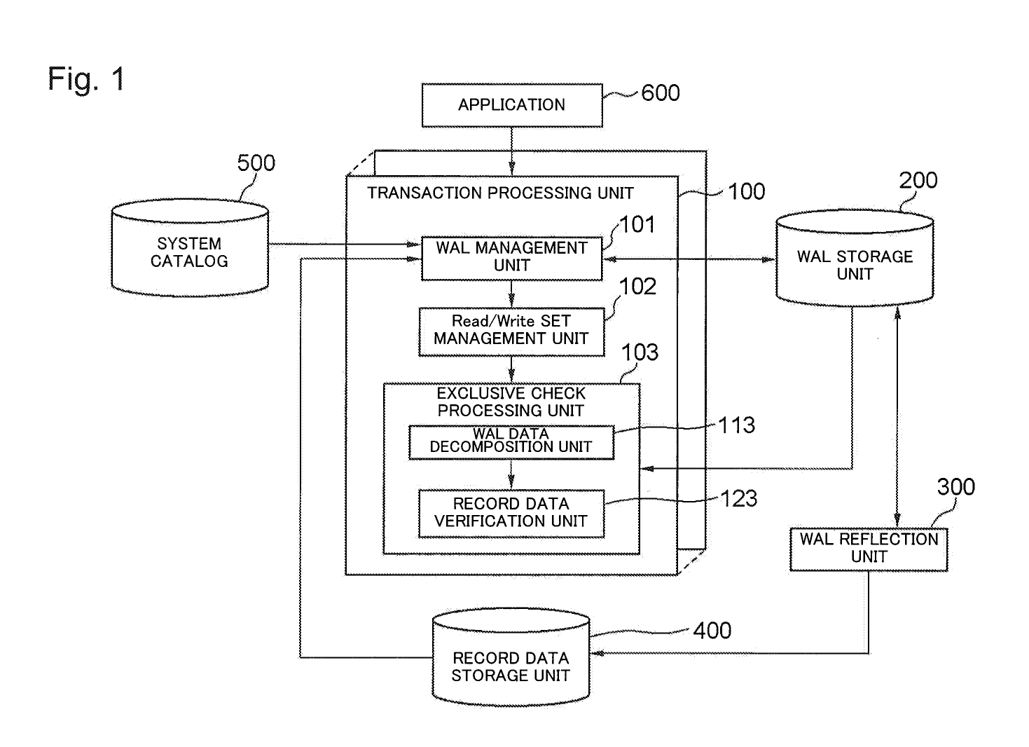

Referring to FIG. 1, a transaction system according to the first exemplary embodiment of the present invention includes: a transaction processing unit 100; a WAL storage unit 200; a WAL reflection unit 300; a record data storage unit 400; and a system catalog 500, where the transaction processing unit 100 further includes: a WAL management unit 101; a read/write set management unit 102; and an exclusive check processing unit 103, while the exclusive check processing unit 103 further includes a WAL data decomposition unit 113 and a record data verification unit 123.

There are one or more transaction processing units 100.

Each transaction processing unit 100 receives a transaction that is input from an application (an application program) 600 and processes the transaction. Each transaction processing unit 100 operates in parallel with the other transaction processing units 100.

The WAL management unit 101 creates a data group, for a transaction input from the application 600, that logically groups records to be used in the transaction, and writes and reads the update content as a WAL to and from the WAL storage unit 200 using a CAS (Compare And Swap) command or the like.

In the following, the WAL (Write Ahead Log) will be described. Write Ahead Logging means, in general, writing a content to be changed in a log before operation to a database, where a WAL is such a log. Accordingly, a change to a database is recorded in a log first, and then, reflected from the log into the database.

The WAL storage unit 200 stores the WAL that are generated or updated by the WAL management unit 101. The WAL storage unit 200 is provided commonly in a plurality of transaction processing units 100. In the first exemplary embodiment, the WAL storage unit 200 is configured as KVS, and the WAL is stored as KV data including Key and Value. KVS can assure atomicity for a piece of KV data using, for example, a CAS command, yet, cannot atomically process a plurality of records in one transaction. In such manner, a plurality of records can be processed transactionally by generating a data group that logically groups a plurality of records and writing the update content of the data group as a WAL in KVS.

The read/write set management unit 102 extracts information of record that is referenced or updated by a transaction input from the application 600. Information of a reference record, an update record, and the like that is extracted by the read/write set management unit 102 is passed on to the exclusive check processing unit 103.

Upon commitment of the transaction, the exclusive check processing unit 103 compares the WAL data that is added to the WAL storage unit 200 during from the start of the transaction until the commitment thereof with the record that is referenced and updated by the transaction, and is given by the read/write set management unit 102. Then, if there is a duplicate record, the transaction is failed, and if there is no duplicate record, the transaction is succeeded. If the transaction is succeeded, the WAL management unit 101 writes the update content of the transaction in the WAL storage unit 200 as a WAL.

The WAL data decomposition unit 113 decomposes the WAL data that is acquired from the WAL storage unit 200 into units of records and acquires the record data included in the WAL data.

The record data verification unit 123 compares the record that is referenced and updated by the transaction with the record data included in the WAL, finds out whether there is a duplicate record. If there is a duplicate record, the transaction is failed, and if there is no duplicate record, the transaction is succeeded.

The WAL reflection unit 300 reflects the record data that is included in the WAL, which is stored in the WAL storage unit 200, in the record data storage unit 400 and deletes the reflected WAL from the WAL storage unit 200. The timing of the operation of the WAL reflection unit 300 may be designated by a timer or designated by a system administrator or the like at arbitrary timing.

The record data storage unit 400 stores the record data. In the first exemplary embodiment, the record data storage unit 400 is configured as KVS, and the record data is stored as KV data including Key and Value. While the WAL storage unit 200 and the record data storage unit 400 are expressed as separate KVS in FIG. 1, both units may be set as single KVS.

The system catalog 500 stores meta-information of data that is stored in the record data storage unit 400 and data such as information of a data group that is generated upon execution of a transaction. When a transaction is input from the application 600, the WAL management unit 101 extracts information relating to the data group from the system catalog 500 and identifies the data group used in the transaction based on the extracted information.

[Operation]

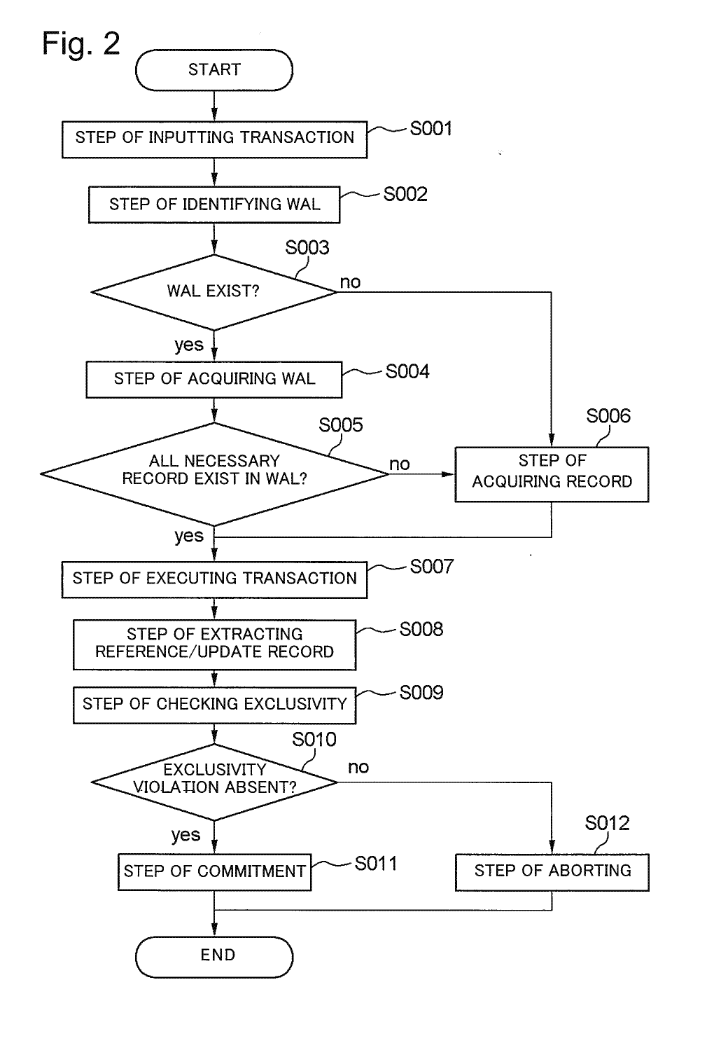

Next, the operation of the first exemplary embodiment will be described. In the first exemplary embodiment, the operation is performed in accordance with the flowchart illustrated in FIG. 2.

First, at step S001 of inputting a transaction, the application 600 inputs a transaction to the system.

Next, at step S002 of identifying a WAL, the WAL management unit 101 analyzes the input transaction, identifies a data group to which the data to be processed in the transaction belongs using information of the system catalog 500, and identifies the WAL in which the past update content of the data group is stored. In this system, a WAL is a piece of KV data that aggregates the history of the update content of a data group that logically groups a plurality of records that are processed in transactions.

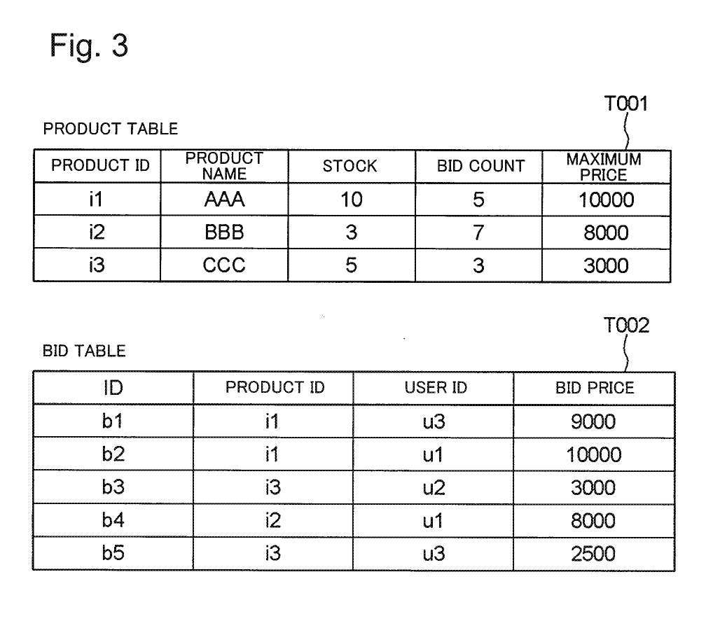

In the following, the concept of the data group in this system will be described. Suppose there are two kinds of data as presented in FIG. 3, that is, a product table T001 and a bid table T002. The following transaction is executed against such data.

“Update data of the product table and the bid table when a user newly performs bidding.”

When processing such a transaction, the data of the product table and the data of the bid table have to be atomically updated. However, as KVS assures atomicity of only a piece of KV data, for example, if updating of the data of the bid table fails after updating the data of the product table, only the data of the product table is updated, which raises a problem where atomicity is not assured.

Thus, in order to assure the atomicity of the transaction, a plurality pieces of data relating to the transaction are logically grouped into a piece of KV data and multiple updates of the data are realized by a single writing task to the KVS.

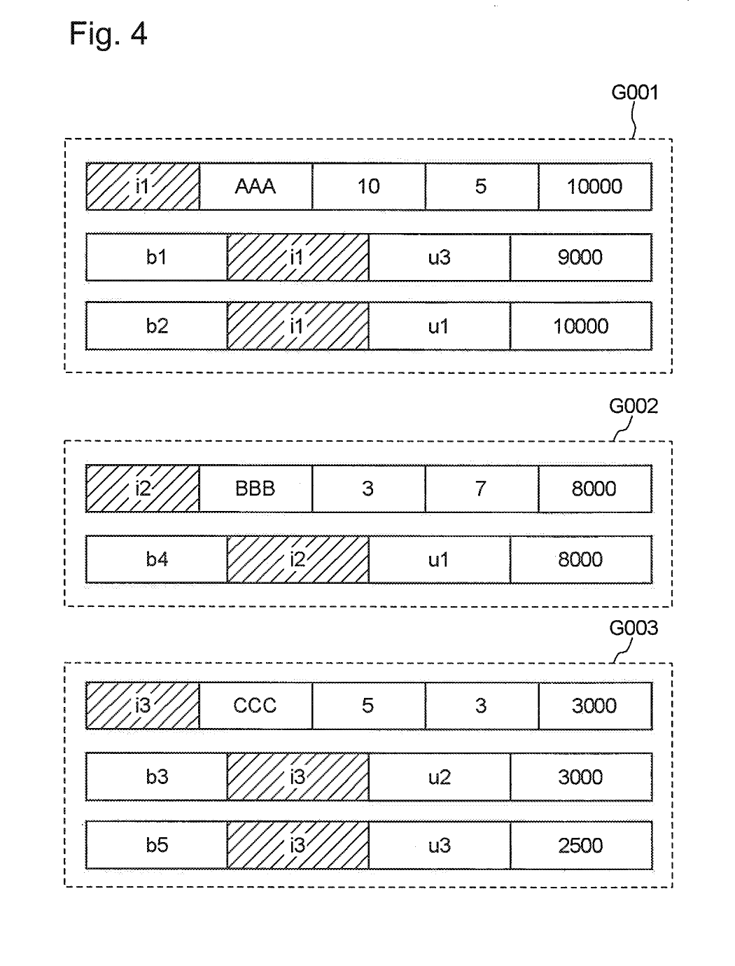

To create a data group, a common key among the data (a product ID in the example of FIG. 3) is extracted. The data presented in FIG. 3 can be logically grouped into three groups (G001, G002, G003) as illustrated in FIG. 4.

In the following, the concept of a WAL in this system will be described. Suppose the following two transactions are sequentially executed against the data presented in FIG. 3:

First transaction: “Update the bid price of the record, of which ID in the bid table T002 is b1, to 12000; update the maximum price of the record, of which product ID in the product table T001 is i1, to 12000.”

Second transaction: “Update the bid price of the record, of which ID in the bid table T002 is b2, to 13000; update the maximum price of the record, of which product ID in the product table T001 is i1, to 13000.”

First, the first transaction 1 updates the data in the first row of the product table T001 and the data in the first row of the bid table T002. The second transaction 2 updates the data in the first row of the product table T001 and the data in the second row of the bid table T002. All the data updated in these two transactions belong to the same data group, and therefore, the update results of these transactions are stored in a single WAL. The WAL is configured by such information as the following:

A Key value for identifying the WAL

The update result of the transaction

As a WAL is KV data, it is expressed by a set of (Key, Value). For a Key value, a prefix that indicates a WAL is added to the common Key value of the data group. In the above example, WAL_i1 is the Key value of the WAL. The Value value includes an update result of a transaction. In particular, the WAL is configured as follows:

WAL=(Key, Value)=(WAL_i1, <[(i1, AAA, 10, 5, 12000), {b1, i1, u3, 12000}, timestamp1], [{i1, AAA, 10, 5, 13000}, {b2, i1, u1, 13000}, timestamp2]>)

The timestamp expresses the order in which the transaction against the WAL was executed. Timestamps may be expressed by simple numerical values. Accordingly, a WAL indicates an update history with respect to a certain data group.

In particular, at step S002 of identifying a WAL, the WAL management unit 101 identifies a WAL as follows.

First, based on the input transaction, the WAL management unit 101 extracts tables that are used in the transaction and extracts information relating to the data group among the tables used in the transaction from the system catalog 500.

The system catalog 500 stores information as to which tables and which columns constitute a data group as well as the schema information of tables. For example, in the case of data presented in FIG. 3, information such as “a data group is configured by a product table T001 and a bid table T002; a Key for configuring the data group is a product ID” is stored.

The WAL management unit 101 identifies a data group that is used in the transaction based on the input transaction and the information of the system catalog 500. For example, if a transaction such as “update the bid price of the record, of which ID in the bid table T002 is b1, to 12000 and update the maximum price of the record, of which product ID in the product table T001 is i1, to 12000” is input, it is understood that the tables to be used in the transaction are the product table T001 and the bid table T002 and it is also understood from the system catalog 500 that the product table T001 and the bid table T002 are grouped by the product ID. As such, it is understood that the WAL to be acquired is WAL_i1, whereby, the WAL to be used in the transaction can be identified.

Next, using the information of the WAL identified at step S002 of identifying a WAL, the WAL management s-unit 101 acquires the WAL from the WAL storage unit 200 (step S003). If there is the WAL in the WAL storage unit 200, the WAL management unit 101 acquires the WAL from the WAL storage unit 200 at step S004 of acquiring the WAL. At this point, the latest timestamp of the WAL is acquired from the WAL storage unit 200 for use in a later exclusivity check.

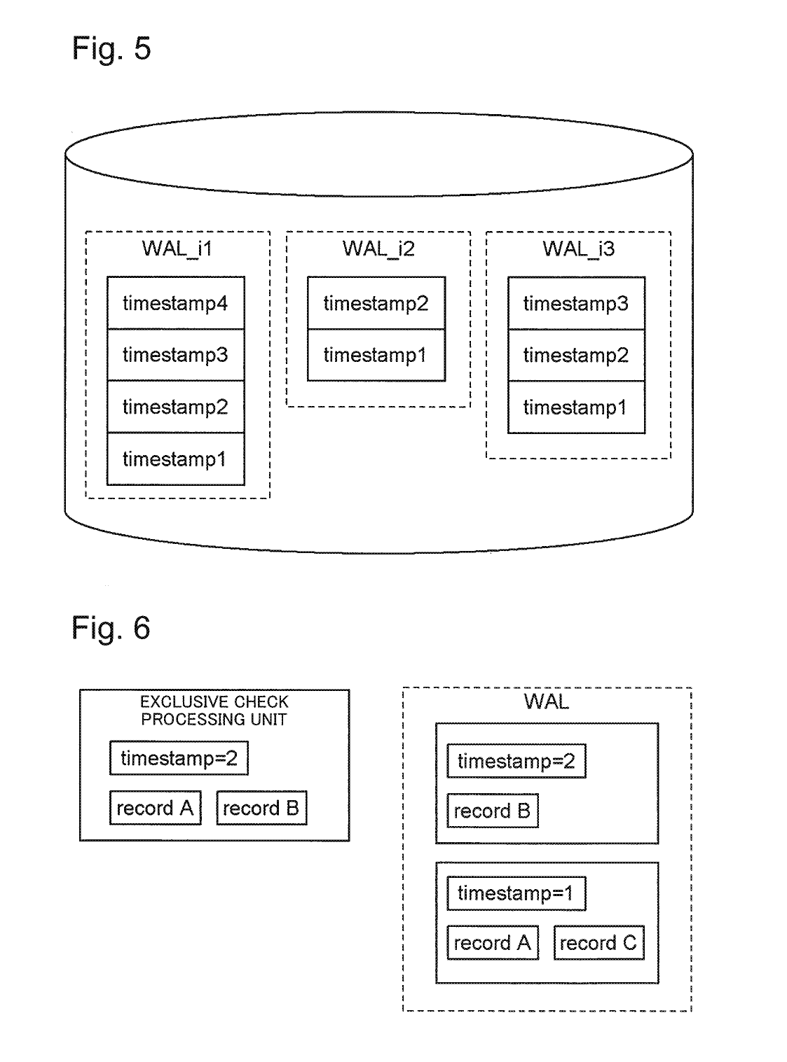

With reference to FIG. 5, how WALs are stored in the WAL storage unit 200 will be described.

WALs are stored in such a manner that each WAL has a history in the WAL storage unit 200. For example, if a certain transaction is executed using WAL_i1, the WAL is accumulated as WAL_i1 having timestamp 1, then, if the next transaction is executed using WAL_i1, the WAL is accumulated as WAL_i1 having timestamp 2. If the following transaction is executed using WAL_i2, the WAL is accumulated as WAL_i2 having timestamp 1.

For records included in the respective WALs, the update history and the latest record value can be found by checking the data of the WALs sequentially from those with older timestamp values.

If there is no corresponding WAL in the WAL storage unit 200, the WAL management unit 101 acquires record data to be used in the transaction from the record data storage unit 400 at step S006 of acquiring records.

How records are stored in the record data storage unit 400 will be described. As the record data storage unit 400 is KVS, the record data is stored as data that is expressed by a set of (Key, Value).

In the record data as shown in FIG. 3, the primary key is a Key value and other columns are stored as Value values. In particular, the records are stored as follows:

(Key, Value)=(i1, {AAA, 10, 5, 10000})
(Key, Value)=(b1, {i1, u3, 9000})

Even if there is a corresponding WAL in the WAL storage unit 200, all necessary record data may not be included in the WAL stored in the WAL storage unit 200. The following illustrates such a case.

For example, suppose the following transaction is executed by Transaction 1.

“Update the bid price of the record, of which ID in the bid table T002 is b1, to 12000; update the maximum price of the record, of which product ID in the product table T001 is i1, to 12000.”

Suppose there is no corresponding WAL, and a new WAL of WAL_i1 is generated and stored in the WAL storage unit 200. At this point, the WAL stored as a WAL of WAL_i1 is as follows, which includes a record in the first row of the product table T001 and a record in the first row of the bid table T002 as record data.

WAL=(WAL_i1, [{i1, AAA, 10, 5, 12000}, {b1, i1, u3, 12000}, 1])

Next, suppose the following transaction is executed by Transaction 2.

“Update the bid price of the record, of which ID in the bid table T002 is b2, to 13000; update the maximum price of the record, of which product ID in the product table T001 is i1, to 13000.”

When the above Transaction 2 is input, the WAL management unit 101 identifies WAL_i1 and acquires the WAL of WAL_i1 from the WAL storage unit 200. At this point, only a WAL of timestamp 1 is included in WAL_i1, and the WAL includes a record in the first row of the product table T001 and a record in the second row of the bid table T002 as record data. However, as Transaction 2 updates the record in the first row of the product table T001 and the record in the second row of the bid table T002, the data necessary for the transaction is not satisfied only by acquiring the WAL.

Thus, after acquiring the WAL from the WAL storage unit 200, the WAL management unit 101 checks whether all data necessary for processing the transaction is included in the WAL (step S005). If the necessary data is not included in the WAL, a necessary portion of records is acquired from the record data storage unit 400 (step S006).

After acquiring all the data necessary for the transaction from the WAL and the record data, the data is used to proceed the processing of the transaction. Then, at step S007 of executing the transaction, the WAL management unit 101 generates an update image of the data group by the transaction as a new WAL. At this point, the WAL management unit 101 does not write the newly generated WAL in the WAL storage unit 200.

Next, at step S008 of extracting reference/update records, the read/write set management unit 102 extracts record information that is referenced or updated by the transaction. In particular, information of the records that were updated or referenced in the transaction and the timestamp information at the start time of the transaction is acquired from the WAL management unit 101. Note that the record information that is retained by the read/write set management unit does not have to be the whole record data; a Key value of each record may be sufficient for the record information.

The read/write set management unit 102 outputs the retaining record information to the exclusive check processing unit 103. All record information that includes the referenced record information and updated record information may be output, or only the information of the updated record may be output. The isolation level among transactions can be adjusted based on whether all reference and update record information is output or only updated record information is output. Which kind of record information is output may be set in advance by a system administrator or the like before activation of the system.

Next, at step S009 of checking exclusivity, the exclusive check processing unit 103 compares the WAL data that is added to the WAL storage unit 200 between the start of the transaction up to the present time with the record that is referenced and updated in the transaction, and is provided from the read/write set management unit 102 (step S010). Then, if there is a duplicate record, the transaction is failed (step S012), and if there is no duplicate record, the transaction is succeeded (step S011).

In particular, first, the exclusive check processing unit 103, receives the record data that was referenced or updated in the transaction and the start time timestamp value from the read/write set management unit 102. Next, the WAL used in the transaction is acquired from the WAL storage unit 200.

If the latest timestamp of the WAL acquired from the WAL storage unit 200 is the same as the start time timestamp that is received from the read/write set management unit 102, this means no other transactions with regard to the WAL were executed between the start of the transaction to the present time, and therefore, the transaction is succeeded.

If the latest timestamp of the WAL acquired from the WAL storage unit 200 is a value larger than the start time timestamp value that is received from the read/write set management unit 102, this means other transactions with regard to the WAL were executed between the start of the transaction to the present time, and therefore, whether there is an exclusivity violation is checked.

Checking of an exclusivity violation is executed as follows. First, the WAL data decomposition unit 113 extracts all WAL data that has timestamp values larger than the timestamp value received from the read/write set management unit 102 among the WAL data acquired from the WAL storage unit 200. Then, the extracted WAL data is decomposed into units of records, and the record data included in the WAL data is extracted.

Next, the record data verification unit 123 checks whether there is a duplicate record between the record data included in the extracted WAL data and the record data received from the read/write set management unit 102. If there is at least one duplicate record, this means there is an exclusivity violation, and therefore, the transaction is failed. If there is no duplicate record, this means there is no exclusivity violation, and therefore, the transaction is succeeded.

FIGS. 6, 7, and 8 illustrate conceptual diagrams illustrating the cases where the exclusive check processing unit 103 causes the transaction to succeed and fail.

FIG. 6 is an example of a case where there is no update for the WAL during from the start of the transaction until the exclusive check processing unit 103 checks exclusivity. In such a case, as no other transactions with regard to the WAL are executed during the execution of the transaction, the transaction succeeds.

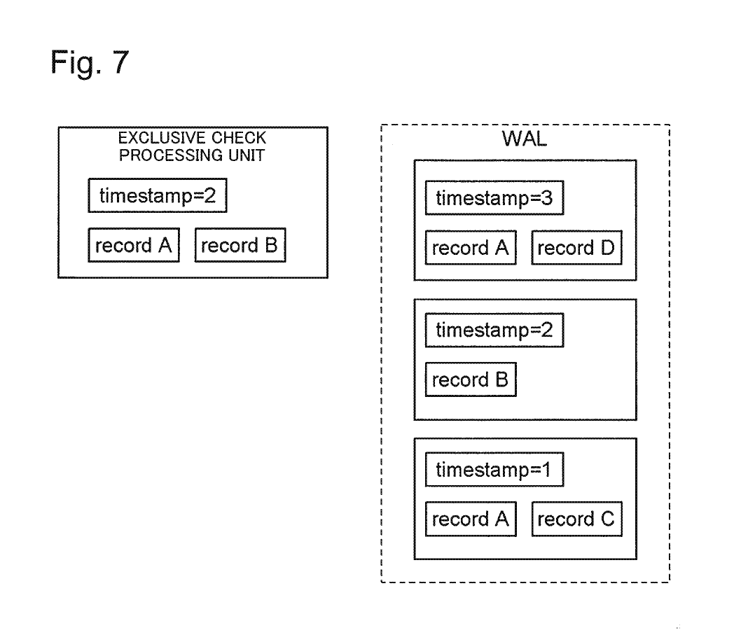

FIG. 7 is an example of a case where there is an update for the WAL during from the start of the transaction until the exclusive check processing unit 103 checks exclusivity. In such a case, WAL data that has a larger timestamp value than the start time timestamp value that is retained in the exclusive check processing unit 103 is extracted. In the example of FIG. 7, the WAL data whose timestamp is 3 is acquired. In the example of FIG. 7, the WAL data whose timestamp is 3 includes a record A and a record D. That is, other transactions for updating the record A and record D have been executed at the time between the start of the transaction to the check for exclusivity by the exclusive check processing unit 103. Thus, as an exclusivity violation to the record A will occur if the transaction is executed, the transaction is failed.

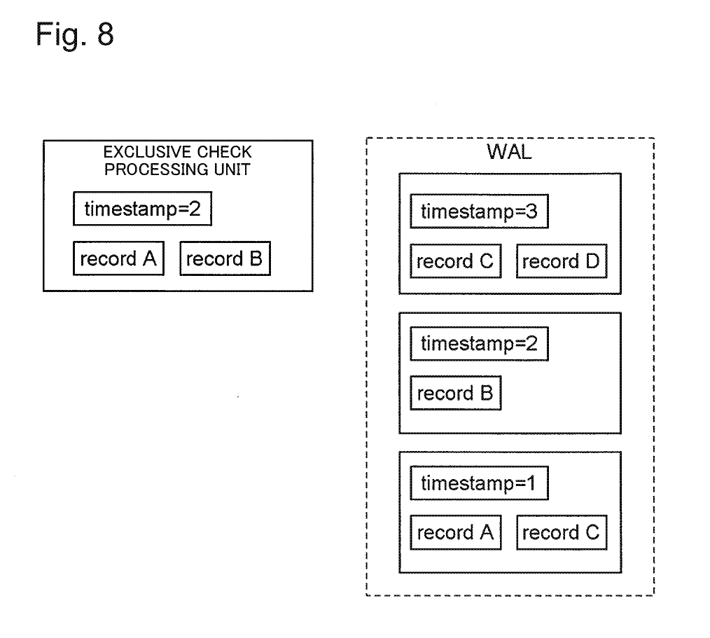

FIG. 8 is an example of a case where there is an update for the WAL during from the start of the transaction until the check for exclusivity by the exclusive check processing unit 103. In such a case, the WAL data that has a larger timestamp value than the start time timestamp value or a same timestamp value with the start time timestamp value retained in the exclusive check processing unit 103 is extracted. In the example of FIG. 8, the WAL data whose timestamp value is 3 is acquired. In the example of FIG. 8, the WAL data whose timestamp is 3 includes a record C and a record D. In other words, other transactions that update the record C and the record D are executed at the time between the start of the transaction and execution of the check for exclusivity by the exclusive check processing unit 103. Thus, as no exclusivity violation will occur in a code level even if the transaction is executed, the transaction is succeeded.

If the exclusive check processing unit 103 does not detect any exclusivity violation, the exclusive check processing unit 103 requests the WAL management unit 101 to commit the transaction. When commitment of the transaction is requested, the WAL management unit 101 writes the WAL data of the transaction in the WAL storage unit 200 (step S011). At this point, the timestamp value of the WAL to be written therein will be a value following the latest timestamp value that is stored in the WAL storage unit 200. For example, in the case of FIG. 6, the timestamp of value 3 is added to the updated records A, B before being written in the WAL storage unit 200. Further, for example, in the case of FIG. 8, the timestamp of value 4 is added to the updated records A, B before being written in the WAL storage unit 200.

If the exclusive check processing unit 103 detected an exclusivity violation, the exclusive check processing unit 103 requests the WAL management unit 101 to abort the transaction.

When abort of the transaction is requested, the WAL management unit 101 discards the WAL data of the transaction (step S012).

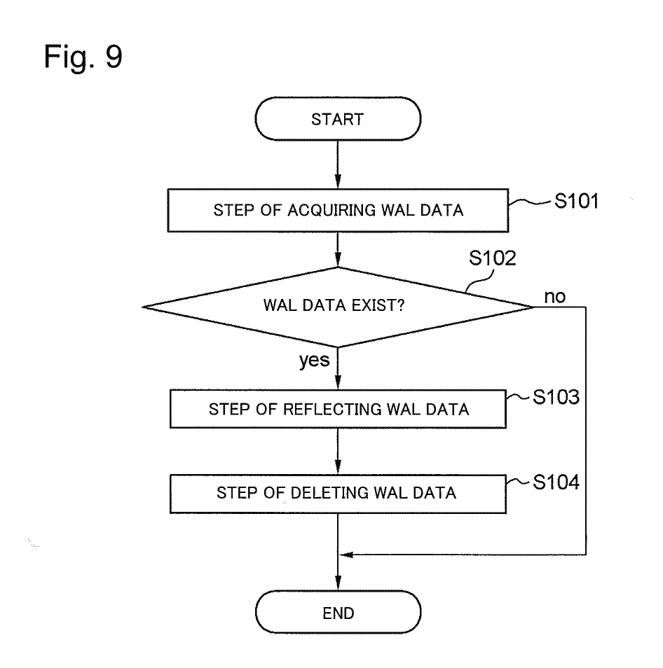

In the following, operation of reflecting the WAL data in the record data storage unit 400 in the first exemplary embodiment will be described. The operation of reflecting the WAL data is performed in accordance with the flowchart illustrated in FIG. 9.

First, at step S101 of acquiring WAL data, the WAL reflection unit 300 acquires all stored WAL data from the WAL storage unit 200.

If there is no WAL data in the WAL storage unit 200, the processing of reflecting the WAL ends (NO at step S102).

If there is WAL data in the WAL storage unit 200 (YES at step S102), at step S103 of reflecting WAL data, the WAL reflection unit 300 extracts record data included in the WAL data acquired from the WAL storage unit 200 and reflects the extracted record data in the record data storage unit 400.

The WAL data that the WAL reflection unit 300 acquired from the WAL storage unit 200 may possibly include plurality pieces of duplicate record data. If plurality pieces of duplicate record data are included, the record data included in the WAL with the largest timestamp value is the latest data with regard to the record data, and therefore, this record data is reflected in the record data storage unit 400.

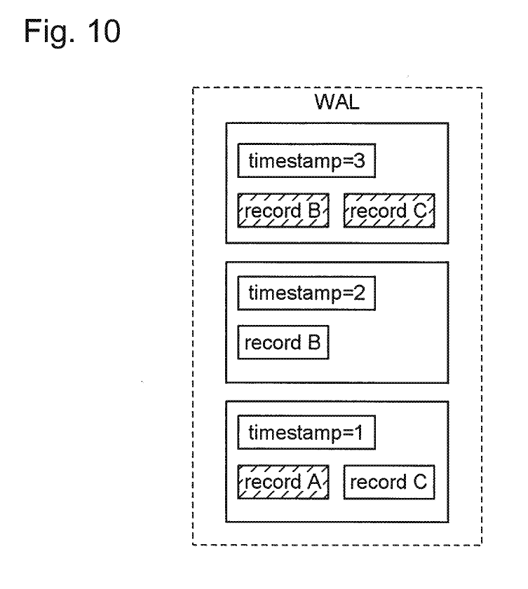

The details will be described with reference to FIG. 10. If the WAL reflection unit 300 acquires a WAL as illustrated in FIG. 10 from the WAL storage unit 200, the one included in the WAL data with timestamp 1 is the latest for record A, and therefore, this data is reflected in the record data storage unit 400. For the record B and record C, those included in the WAL data with timestamp 3 is the latest, and therefore, this data is reflected in the record data storage unit 400.

Finally, at step S104 of deleting WAL data, the WAL reflection unit 300 deletes the WAL data that is extracted from the WAL storage unit 200 and reflects in the record data storage unit 400. While transactions may possibly be executed and new WAL may be added from when the WAL reflection unit 300 acquires data from the WAL storage unit 200 until the WAL reflection unit 300 reflects it, the newly added WAL is not deleted.

If data already exists in a WAL for a certain record, the record data that is stored in the WAL is the latest information for the record, and therefore, the latest data for the record is stored in the record data storage unit 400 at the time when the WAL reflection unit 300 reflects the record data in the record data storage unit 400. If no data exists in a WAL for a certain record, the record data stored in the record data storage unit 400 is the latest information for the record.

Note that the process of processing a transaction that is input from the application and the process of reflecting WAL are performed respectively in parallel. The process of reflecting WAL may be performed at certain time intervals by a timer or by a system administrator or the like at arbitrary timing.

[Effect]

In a system that supports a transaction of a plurality of records in KVS, the first exemplary embodiment allows exclusive control of transaction which causes to perform exclusive control in units of records that are referenced and updated in the transaction, not to performing exclusive control in units of data groups to which the transaction is executed, thereby reducing the units of exclusion of transactions, enhancing simultaneity in execution of transactions, and leading to higher throughput.

### Second Exemplary Embodiment

In the following, the second exemplary embodiment of the present invention will be described.

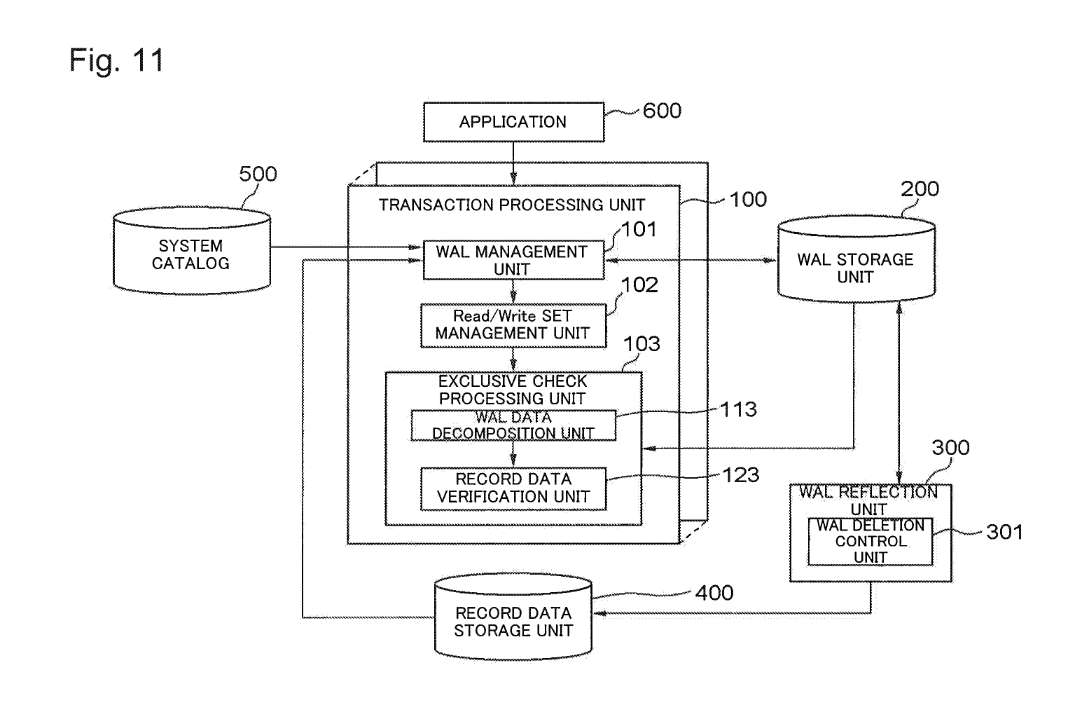

As illustrated in FIG. 11, the second exemplary embodiment is different in that the WAL reflection unit 300 further includes a WAL deletion control unit 301 therein in addition to the components of the first exemplary embodiment illustrated in FIG. 1.

In the second exemplary embodiment, after reflecting WAL data in the record data storage unit 400, the WAL reflection unit 300 keeps a certain amount of WAL data undeleted instead of deleting all the reflected WAL data.

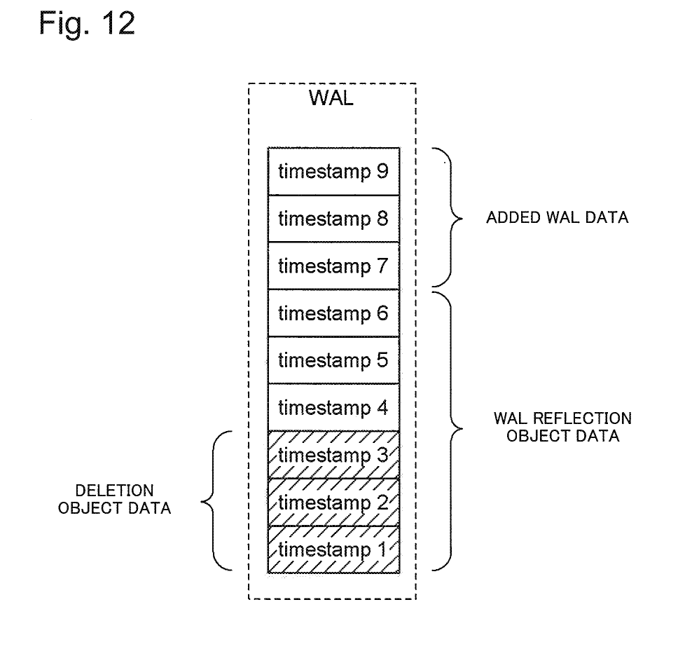

FIG. 12 illustrates a conceptual diagram of WAL data management by the WAL reflection unit 300 in the second exemplary embodiment. Suppose there is WAL data with timestamps 1 to 6 upon execution of processing of the WAL reflection unit 300. The WAL deletion control unit 301 has information of how much WAL data is kept undeleted among the reflected WAL data upon deletion of the WAL data after reflecting the WAL data. In the example illustrated in FIG. 12, the WAL deletion control unit 301 has information of keeping three pieces of WAL data undeleted. The WAL data with timestamps 7 to 9 is WAL data that is newly generated by transactions that have been executed from when the WAL reflection unit 300 started the WAL reflection processing until when the WAL reflection unit 300 ended the WAL reflection processing. In such manner, new WAL data is consecutively accumulated by execution of transactions.

The WAL reflection processing of the second exemplary embodiment is basically performed in the same procedure as the flowchart illustrated in FIG. 9.

First, at step S101 of acquiring WAL data, the WAL reflection unit 300 acquires all the stored WAL data from the WAL storage unit 200.

Next, at step S102 of reflecting WAL data, the WAL reflection unit 300 extracts record data included in the WAL data acquired from the WAL storage unit 200, and then, reflects the extracted record data in the record data storage unit 400.

Finally, at step S103 of deleting WAL data, the WAL deletion control unit 301 deletes the WAL data while keeping N number (N is a natural number) of reflected WAL data in the order from the largest timestamp. In other words, a predetermined number of WAL data with newer timestamps are kept undeleted.

In the following, the effect of keeping part of WAL data instead of deleting all the reflected WAL data will be described. As the process of executing a transaction and the process of reflecting WAL respectively operate in parallel, the process of reflecting the WAL may possibly operate from the start of the transaction until commitment thereof.

If the WAL reflection processing operates from the start of a certain transaction until commitment thereof, all the WAL data relating to the transaction will be deleted from the WAL storage unit 200. After the WALs are deleted, an attempt to check exclusivity of the transaction data fails to determine the presence or absence of an exclusivity violation, since the WAL data no longer exists. Accordingly, a transaction that supposedly succeeds may fail. On the contrary, if the WAL reflection processing does not delete all data, leaving sufficient WAL data for checking exclusivity of the transaction, the exclusivity violation of the transaction can be accurately detected.

For example, with regard to FIGS. 6 to 8 that are referred to in relation with the first exemplary embodiment of the present invention, the absence of an exclusivity violation is detected in the cases of FIGS. 6 and 8 and the presence of an exclusivity violation is detected in the case of FIG. 7 on the basis of the state of the WAL enclosed by the broken line on the right side. If all the WALs enclosed by the broken line on the right side are deleted in FIGS. 6 to 8, such a detection becomes difficult. In such a case, exclusivity violations should be inevitably determined in all cases of FIGS. 6 to 8 for the sake of safety, thereby decreasing the simultaneity in execution of transactions.

Accordingly, in the second exemplary embodiment, by keeping part of the WAL data instead of deleting all the WAL data that are reflected by the WAL reflection unit 300, transaction that supposedly does not fail can be succeeded by avoiding failures in execution of transaction due to the absence of the WAL data, thereby enhancing simultaneity in execution of transactions and leading to higher throughput.

Note that the amount of WALs kept undeleted is a matter of trade-off between the desired simultaneity in execution of transactions and the memory capacity to be used. The kept WALs should be smaller in order to save the memory capacity to be used, while the kept WALs should be larger in order to increase the simultaneity in execution of transactions.

The amount of kept WALs, which are controlled by the WAL deletion control unit 301, may be a fixed value or automatically adjusted in response to a feedback from the amount of failed transactions of which exclusivity could not be checked due to the absence of the WALs. In other words, the amount of kept WALs may be made larger if the amount of failed transactions of which exclusivity could not be checked is large, while the amount of kept WALs may be made smaller if the amount of failed transactions of which exclusivity could not be checked is small.

Further, the structure of the WAL in the second exemplary embodiment is as follows:

A Key value for identifying the WAL

The update result of the data group

A WAL reflection position

In other words, the WAL reflection position is newly added compared with the first exemplary embodiment. The WAL reflection position indicates the position of data that was reflected in the record data storage unit 400 among the WAL data. In the example of the WAL data presented in FIG. 12, the WAL reflection position is timestamp 6. The WAL management unit 101 or the like recognizes which data among the WAL data has been reflected in the record data storage unit 400 by referencing the WAL reflection position when acquiring the WAL data from the WAL storage unit 200. Likewise, the WAL reflection unit 300 recognizes which data among the WAL data has been reflected in the record data storage unit 400 by referencing the WAL reflection position when acquiring the WAL data from the WAL storage unit 200.

### Third Exemplary Embodiment

In the following, the third exemplary embodiment of the present invention will be described.

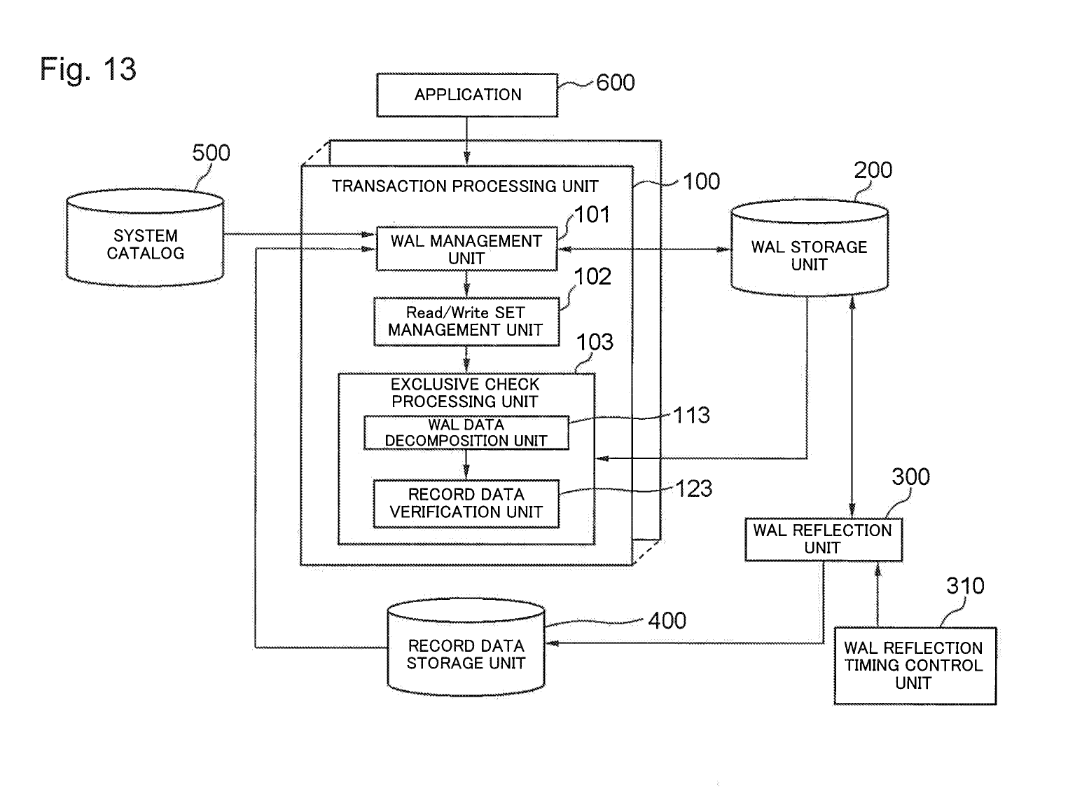

As illustrated in FIG. 13, the third exemplary embodiment is different in that a WAL reflection timing control unit 310 is provided in addition to the components of the first exemplary embodiment illustrated in FIG. 1.

In the third exemplary embodiment, the WAL reflection unit 300 performs WAL reflection processing according to a designation from the WAL reflection timing control unit 310 instead of an operation designation at certain time intervals or by a system administrator or the like.

The WAL reflection processing is processing with high load as it reflects record data included in all WALs in the record data storage unit 400. Therefore, when a high load is placed on a system to which transactions are frequently input from an application, operation of the WAL reflection processing places a further load on the system, thereby affecting the performance of processing transactions. On the other hand, as the WALs include all update histories of record data, the use capacity of the storage device for storing the WALs becomes large if the WALs are kept without being reflected.

The WAL reflection timing control unit 310 monitors the load condition of the present system and the use amount of the storage device, and, when the load of the system is low or when the use amount of the storage device becomes large, designates operation to the WAL reflection unit 300.

For example, using an evaluation formula as the following, the WAL reflection timing control unit 310 designates operation to the WAL reflection unit 300 when the evaluation value exceeds a certain threshold.

Evaluation value=W1*CPU idle state+W2*(the use amount of storage device/the entire capacity of storage device)

In the above evaluation formula, W1 and W2 are weight coefficients that are used to adjust whether to prioritize the load condition of the system or the use amount of the storage device. For example, if W1 is large, the operation places a priority on the load condition of the system. The weight coefficient, such as W1 and W2, the threshold of the evaluation formula, and the like, may be set in advance by the system administrator before activation of the system.

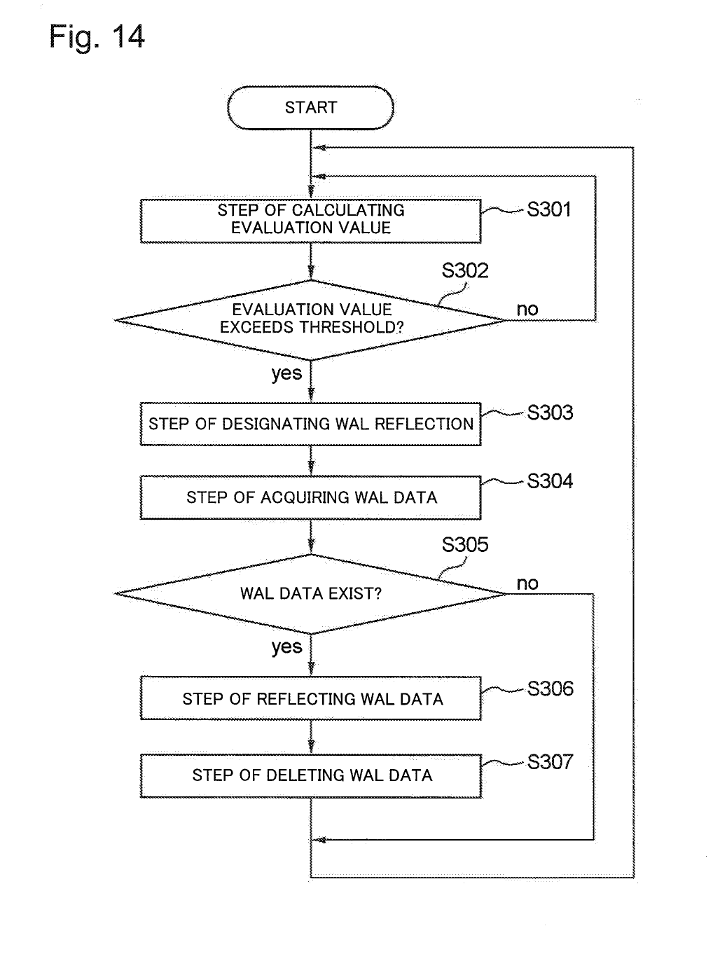

FIG. 14 illustrates a flowchart of the WAL reflection processing in the third exemplary embodiment.

First, at step S301 of calculating an evaluation value, the WAL reflection timing control unit 310 calculates an evaluation value.

Next, the WAL reflection timing control unit 310 determines whether the evaluation value calculated at step S301 exceeds the threshold (step S302). If the evaluation value does not exceed the threshold, the processing returns to step S301 of calculating an evaluation value. If the evaluation value exceeds the threshold, the WAL reflection timing control unit 310 designates operation to the WAL reflection unit 300.

The WAL reflection unit 300 that received an operation designation from the WAL reflection timing control unit 310 performs the WAL reflection processing. The description of the operation after step S304 is omitted, as it is the same as the operation flow of reflecting WAL shown in FIG. 9.

Accordingly, in the third exemplary embodiment, the resources of a computer on which the system runs can be efficiently used when the WAL reflection timing control unit 310 controls the operation timing of reflecting WAL in consideration of the load condition of the system, the use amount of the storage device, and the like.

### Fourth Exemplary Embodiment

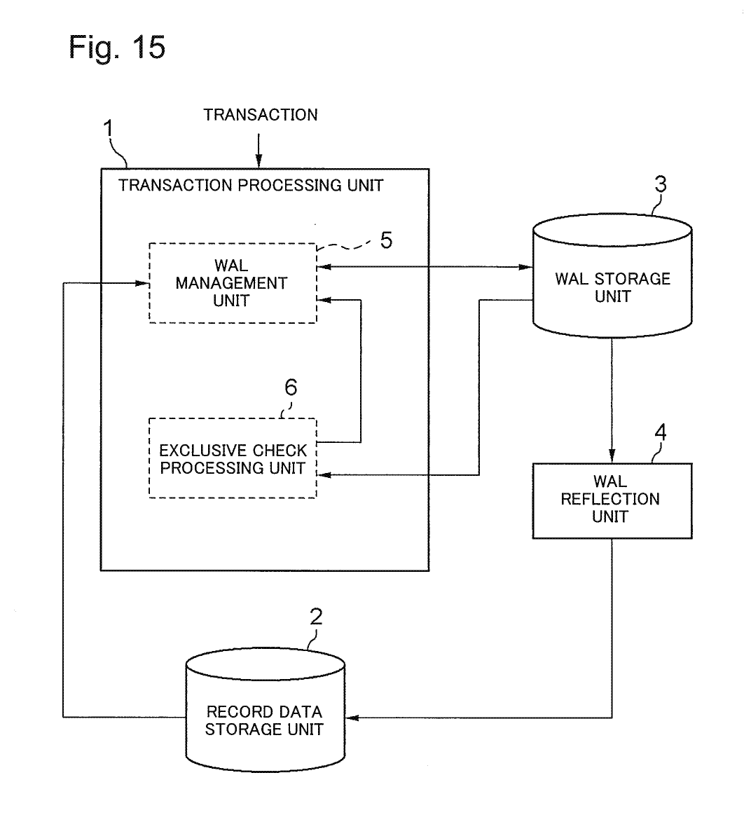

FIG. 15 is a block diagram of a fourth exemplary embodiment of the present invention. As illustrated in FIG. 15, according to the fourth exemplary embodiment, at least one transaction processing unit 1, a record data storage unit 2, a WAL storage unit 3, and a WAL reflection unit 4 are provided.

The record data storage unit 2 is configured by a semiconductor memory, a magnetic disc, and the like, and stores records that are expressed by sets of keys and values.

The WAL storage unit 3 is configured by a semiconductor memory, a magnetic disc, or the like, which stores update histories in units of data groups, each of which aggregates a plurality of the records into a piece of key-value data. Preferably, the WAL storage unit 3 stores update logs expressed by a set of key and value. The above key is a value that uniquely identifies a data group that is data that aggregates a plurality of the records. The above value indicates the update history of the above data group. Further, the above update history includes one or more pieces of partial update histories. Each of the above partial update histories includes the update content of the records that constitute the data group and a timestamp that indicates the updating order.

The transaction processing unit 1 has a function of executing transactions that are input from an application program or the like that is not illustrated. Upon commitment of a transaction that references and updates a data group, the transaction processing unit 1 determines the presence or absence of an exclusivity violation in units of records based on the update history stored in the WAL storage unit 3. Then, if there is no exclusivity violation, the transaction is succeeded and the update history is stored in the WAL storage unit 3. Preferably, the transaction processing unit 1 includes the WAL management unit 5 and the exclusive check processing unit 6 as main functional units.

The WAL management unit 5 has a function of acquiring the latest values of the records that constitute the above data group, which is used in the input transaction, from the WAL storage unit 3 and the record data storage unit 2. Further, the WAL management unit 5 has a function of acquiring the above latest timestamp in the above update log corresponding to the data group as a start time timestamp from the WAL storage unit 3.

The exclusive check processing unit 6 has a function of, upon commitment of a transaction executed by the transaction processing unit 1, comparing the start time timestamp that is acquired upon the start of the transaction with a commit time timestamp that is the latest timestamp of the data group that is currently stored in the WAL storage unit 3. Further, the exclusive check processing unit 6 has a function of, if the start time timestamp and the commit time timestamp are different as the result of the above comparison, determining the presence or absence of a duplicate record of the records that are used in the transaction in a partial update history that has a timestamp that is later than the start time timestamp. Further, the exclusive check processing unit 6 has a function of determining whether to cause the transaction to succeed or fail based on the above comparison and the determination and, if the transaction is determined to succeed, adding a new partial update history that has the update contents of the records that are updated in the above transaction and a timestamp later than the commit time timestamp to the update log that is currently stored in the WAL storage unit 3 corresponding to the above data group.

The WAL reflection unit 4 has a function of reflecting the update contents of the records that are in the update history, which is stored in the WAL storage unit 3, in the record data storage unit 2.

The transaction system of the fourth exemplary embodiment can be realized by a computer that has, for example, a processor, such as MPU, and a memory, an input and output device, a communication interface, and the like that are connected to the processor, and a program executed in the computer. The program is stored in a computer-readable recording medium, such as a magnetic disc device, and realizes the WAL management unit 5, the exclusive check processing unit 6, and the WAL reflection unit 4 on the processor by being read by the processor such as MPU, upon activation of the computer and controlling the operation of the processor.

In the following, the operation of the fourth exemplary embodiment will be described.

The transaction processing unit 1 executes a transaction that is input. Upon commitment of a transaction that references and updates a data group, the transaction processing unit 1 determinates the presence or absence of an exclusivity violation in units of records based on the update history stored in the WAL storage unit 3. Then, if there is no exclusivity violation, the transaction is succeeded and the update history is recorded in the WAL storage unit 3. Thereafter, the WAL reflection unit 4 reflects the update contents of the records that are in the update history, which is stored in the WAL storage unit 3, in the record data storage unit 2.

More preferably, the fourth exemplary embodiment operates as the following.

When a transaction is input, the transaction processing unit 1 acquires the latest values of records that constitute a data group that is used in the transaction from the WAL storage unit 3 and the record data storage unit 2, and acquires the latest timestamp in the update log corresponding to the data group as a start time timestamp from the WAL storage unit 3, then, starts execution of the transaction.

Upon commitment of the executing transaction, the transaction processing unit 1 compares the above start time timestamp that was acquired at the start of the transaction and a commit time timestamp that is the latest timestamp of the data group that is currently stored in the WAL storage unit 3. Next, if the start time timestamp is different from the commit time timestamp, the transaction processing unit 1 reads all the partial update histories that have timestamps later than the start time timestamp from the WAL storage unit 3 and determinates whether there is a duplicate record of the records that were used in the transaction (referenced and updated record or updated record) in the partial update histories.

The transaction processing unit 1 determines whether to cause the transaction to succeed or fail based on the results of the above comparison and determination. In particular, the transaction is succeeded if the start time timestamp is the same as the commit time timestamp, or otherwise, if there is no duplicate record of the records that were used in the transaction (referenced and updated record or updated record) in all the partial update histories that have timestamps later than the start time timestamp. However, the transaction is failed, if the start time timestamp is different from the commit time timestamp and there is a duplicate record of the records that were used in the transaction (referenced and updated record or updated record) in the partial update histories that have timestamps later than the start time timestamp.

If the transaction processing unit 1 determines to cause the transaction to succeed, the transaction processing unit 1 generates a new partial update history that has the update contents of the records updated in the transaction and a timestamp that is later than the commit time timestamp and adds the partial update history to the update log that is currently stored in the WAL storage unit 3 corresponding to the data group used in the transaction. As the update log is a piece of key-value data that is expressed by a set of key and value, the atomicity of data operation can be assured by using a CAS command or the like.

Meanwhile, the WAL reflection unit 4 reflects the update contents of the records that are in the update log, which is stored in the WAL storage unit 3, in the record data storage unit 2, at certain intervals for example. As the record is a piece of key-value data that is expressed by a set of key and value, the atomicity of data operation can be assured by using a CAS command or the like.

Thus, according to the fourth exemplary embodiment, simultaneity in execution of transactions can be enhanced in a system that executes transactions by grouping a plurality of records into a piece of KV data. This is because optimistic exclusion is performed in units of records.

The present invention has been described so far with reference to the above-described exemplary embodiments, without limitation thereto. A variety of modifications that will be understood by those skilled in the art can be made to the configuration and details of the present invention within the scope thereof.

Note that the present invention shall benefit the advantage of the priority right that is claimed based on the patent application of Japanese Patent Application No. 2012-237597 filed on Oct. 29, 2012, in Japan, and the contents described in the patent application shall be included by its entirety herein.

### INDUSTRIAL APPLICABILITY

The present invention can be utilized in a system in which transaction is executed using KVS as a data perpetuating method.

### REFERENCE SIGNS LIST

1 Transaction processing unit
2 Record data storage unit
3 WAL storage unit
4 WAL reflection unit
5 WAL management unit
6 Exclusive check processing unit

What is claimed is:

1. A transaction system comprising:
a record data storage unit that stores records that are each expressed by a set of key and value;
a WAL storage unit that stores an update history in units of data groups, each of which aggregates a plurality of the records into a piece of key-value data,
a transaction processing unit that, upon commitment of a transaction that references and updates the data group, determines the presence or absence of an exclusivity violation in units of the records based on the update history stored in the WAL storage unit, whereupon, if there is no exclusivity violation, the transaction is succeeded and an update history by the transaction is stored in the WAL storage unit; and
a WAL reflection unit that reflects an update content of the records that is in the update history, which is stored in the WAL storage unit, in the record data storage unit.

2. The transaction system according to claim 1, wherein
the WAL storage unit stores an update log that is expressed by a set of key and value, the key is a value that uniquely identifies the data group that is data that aggregates a plurality of the records, the value expresses an update history of the data group, the update history includes at least one partial update history, and each of the partial update history includes the update content of the records that constitute the data group and a timestamp that indicates an order of update,
the transaction processing unit comprising:
a WAL management unit that acquires latest values of the records that constitute the data group, which are used in a transaction that is input from an application program, from the WAL storage unit and the record data storage unit, acquires a latest timestamp in the update log corresponding to the data group as a start time timestamp from the WAL storage unit, and executes the transaction; and
an exclusive check processing unit that compares, upon commitment of the transaction, the start time timestamp that is acquired at start time of the transaction with a commit time timestamp that is the latest timestamp of the data group currently stored in the WAL storage unit and, if the start time timestamp is different from the commit time timestamp, determines whether there is a duplicate record of the records used in the transaction in the partial update history that has a timestamp later than the start time timestamp, determines whether to cause the transaction to succeed or fail based on the results of the comparison and the determination, and, if the transaction is determined to succeed, adds a new partial update history that has the update content of the records that is updated in the transaction and a timestamp later than the commit time timestamp to the update log that is currently stored in the WAL storage unit corresponding to the data group.

3. The transaction system according to claim 2, wherein
the WAL reflection unit keeps a predetermined number of partial update histories with newer time stamps undeleted among a plurality of the partial update histories of the update log that are reflected in the record data storage unit.

4. The transaction system according to claim 3, wherein
the WAL reflection unit records information, which identifies the reflected partial update history that is been kept undeleted, in the update history.

5. The transaction system according to claim 2, wherein
in the determination of existence or non-existence of record, the exclusive check processing unit determines whether there is a duplicate record of the records that are referenced or updated in the transaction, in the partial update histories that have timestamps later than the start time timestamp.

6. The transaction system according to claim 2, wherein
in the determination of existence or non-existence of record, the exclusive check processing unit determines whether there is a duplicate record of the records that are updated in the transaction, in the partial update histories that have timestamps later than the start time timestamp.

7. The transaction system according to claim 1, wherein
the WAL reflection unit determines timing of the reflection based on an idle condition of a CPU that constitutes the transaction system and a use amount of a storage device that constitutes the WAL storage unit.

8. A control method of a transaction system that comprises:
a record data storage unit that stores records that are each expressed by a set of key and value;
a WAL storage unit that stores an update history in units of data groups, each of which aggregates a plurality of the records into a piece of key-value data;
a transaction processing unit; and
a WAL reflection unit,
the method comprising:
upon commitment of a transaction that references and updates the data group, the transaction processing unit determines the presence or absence of an exclusivity violation in units of the records based on the update history stored in the WAL storage unit, whereupon, if there is no exclusivity violation, the transaction is succeeded and an update history by the transaction is stored in the WAL storage unit; and
the WAL reflection unit reflects an update content of the records that is in the update history, which is stored in the WAL storage unit, in the record data storage unit.

9. The control method of the transaction system according to claim 8, wherein
the WAL storage unit stores an update log expressed by a set of key and value, the key is a value that uniquely identifies the data group that is data that aggregates a plurality of the records, the value expresses the update history of the data group, the update history includes at least one partial update history, each of the partial update history includes the update content of the records that constitute the data group and a timestamp that indicates an order of update,
the transaction processing unit acquires latest values of the records that constitute the data group used in a transaction input from an application program, from the WAL storage unit and the record data storage unit, further acquires a latest timestamp in the update log corresponding to the data group as a start time timestamp from the WAL storage unit, executes the transaction,
upon commitment of the transaction, compares the start time timestamp that is acquired at start time of the transaction with a commit time timestamp that is the latest timestamp of the data group that is currently stored in the WAL storage unit, if the start time timestamp is different from the commit time timestamp, determines whether there is a duplicate record of the records used in the transaction in the partial update history that has a timestamp later than the start time timestamp, determines whether to cause the transaction to succeed or fail based on the results of the comparison and the determination; and,
if the transaction is determined to succeed, adds a new partial update history that has the update content of the records that are updated in the transaction and a timestamp later than the commit time timestamp to the update log that is currently stored in the WAL storage unit corresponding to the data group.

10. A computer-readable storage medium storing a program that causes a computer that comprises:
a record data storage unit that stores records each of which is expressed by a set of key and value; and
a WAL storage unit that stores an update history in units of data groups, each of which aggregates a plurality of the records into a piece of key-value data,
to function as:
a transaction processing unit that, upon commitment of a transaction that references and updates the data group, determines whether there is an exclusivity violation in units of the records based on the update history stored in the WAL storage unit, whereupon, if there is no exclusivity violation, the transaction is succeeded and an update history by the transaction is stored in the WAL storage unit; and
a WAL reflection unit that reflects an update content of the records that is in the update history, which is stored in the WAL storage unit, in the record data storage unit.
